(19) United States
(12) Patent Application Publication
(10) Pub. No.: US 2002/0167863 A1
(43) Pub. Date: Nov. 14, 2002

(54) Portable, compact device to monitor rate and quantity of dietary intake to control body weight

(76) Inventors: Wirth Paul Davis, Shawnee, KS (US); David Micheal McDonald, Camdenton, MO (US)

Correspondence Address: Wirth P. Davis, 5425 Goddard Ave., Shawnee, KS, 66203, US

(21) Appl. No.: 09/852,951

(22) Filed: May 11, 2001

(51) Int. Cl. G04B 47/00

(52) U.S. Cl. 368/10

(57) ABSTRACT

In the preferred embodiment, the compact, hand-held food monitor can control the rate of food ingested on a bite to bite time interval basis, and secondly, warn the operator when total bite consumption or quantity of food has been attained at that eating session. The designated programmed settings are arbitrarily chosen by the operator and can be changed at their discretion.

The device is activated to measure designated units of time between ingested bites of food by touching or placing an object, i.e. utensil, on the sensing platform. After a certain lapse of time has occurred, a signal is given which can be visual, audio, or vibrating, prompting the operator to resume with another bite or standard quantity of food. When the total number of bites or units of food, have been ingested, another signal is activated to tell the individual they have reached the limit, or quantity, of food for their setting.

As progress with weight reduction occurs, the food monitor can be utilized for discipline or maintenance purposes at the operator's discretion.

### BACKGROUND—FIELD OF INVENTION

This device addresses the problems of over eating by monitoring and controlling the rate and quantity of food ingested by an individual at meal or snack times.

### BACKGROUND—DESCRIPTION OF PRIOR ART

Obesity is a chronic and increasingly common disease that affects one-third of all Americans. Related health risks from obesity are cardiovascular disease, diabetes, respiratory disease, cancer, gout and hypertension to name a few.

The Step-Wise approach to obesity management is to rule out any pre-existing pathology and then make lifestyle changes or behavior modifications to decrease over-indulgence when eating. Over eating can be directly attributed to the desire to ingest large quantities of food at a rapid rate so that our caloric intake exceeds our daily caloric requirements. Many inventions deal with the nutritional and exercise aspect of managing obesity by evaluating caloric intake and caloric expenditure on a daily basis. Weight reduction and maintenance of our correct body weight can only occur if we monitor the quantity and the rate or speed that we eat on a daily basis. Various feeding events can be programmed from meals, snacks to special nutritional needs.

Adequate signaling methods such as audio, visual or vibrating can be used by the operator to accommodate the eating environment. Audio could be used at home, and visual or vibrating could be used in public eating establishments so as not to be offensive to other patrons close by.

Easily cleaned after use and with protective cover in place, it can be carried in pockets or purses to be used anywhere or any time. It would be manufactured in various colors for increased ascetic value and for personal identification.

The value of this machine to regulate rate of food intake plus governing the quantities will allow ourselves, in order to maintain our body weight, and be healthy is what a metronome is to a pianist, who can produce beautiful music to be enjoyed with that instrument.

Over eating can be directly attributed to desire to eat in great quantities and ingest at a rapid rate so that the ventromedical function of the hypothalamus cannot accurately declare satiety to the body. Eating slower with predetermined healthy quantities of food gives the needed feedback time via neurotransmitters to declare satiety and to cease further ingestion of food, which helps control our weight coupled with exercise.

Ventromedical function of the hypothalamus cannot accurately declare satiety so we will cease eating without proper feedback. Eating slower and with a predetermined quantity of food required, gives the needed “feedback” time via neurotransmitters to tell us when to stop and yet fulfill our nutritional requirements at that time.

Many inventions deal only with the caloric intake and expenditure through activity or exercise to manage obesity. Calorie counters, computer-assisted systems, weighing food, exercise monitoring, can be complicated, inconvenient, cumbersome and difficult to execute on a daily basis. This device can be used anywhere, anytime by the operator who can create a program to their tastes for the various meals of the day.

### SUMMARY

This hand held device which is battery/solar powered, can be used anywhere, anytime by the operator(s) who can create their own programs to meet their requirements on a day to day basis with meals and/or snacks.

The operator can program the device to allow enough lapse time between bites to control the rate of food consumption and also program the total number of bites, which can be consumed at that meal setting. It can be multi-programmed for the requirements of several operators. I have found nothing comparable to this device in searching CCL/128/921 nor 364/413. Operation and advantages will be apparent from considering the ensuing description and drawings.

### DRAWING FIGURES

FIG. 1 shows the (top view) food monitory device with operational and mechanical functions.

FIG. 2 shows the sectioned view of the device including the protective cover which protects it when it is not in use.

(1) Sensitivity plate which activates the device when touched or a utensil or object is placed on top of it

(2) Colored light to warn to cease food or bite intake.

(3) Colored light to signal to commence food or bite intake.

(4) Raised structure to protect upper control features

(5) On/clear button for usage.

(6) Off button to cease operation of device

(7) Set the code for eating session and total number of ingestion units or bites allowed.

(8) On/off button for audible or vibrating warning in lieu of the light feature.

(9) Set the time (seconds) units of consumption or bites.

(10)Mini-speaker for audible sound.

(11)Screen shows the count down between consumption intervals or bites

(12)Screen shows the total number of consumption units that registers for that setting.

(13)Top of device.

(14)Internal or control panel

(15)Base of device.

(16)Protective sliding plate that covers top of device when not in use.

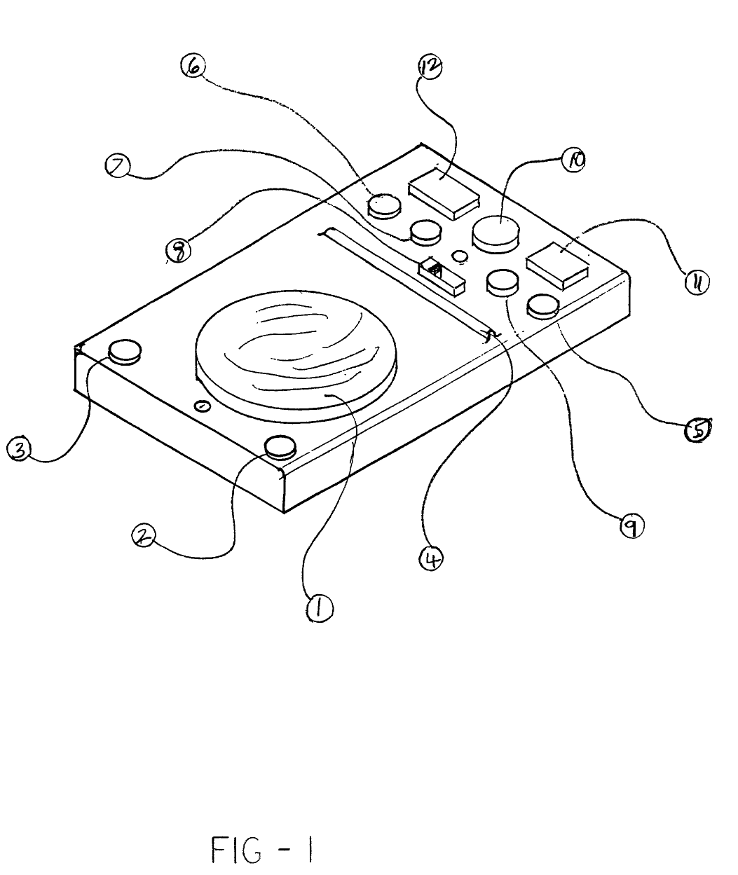

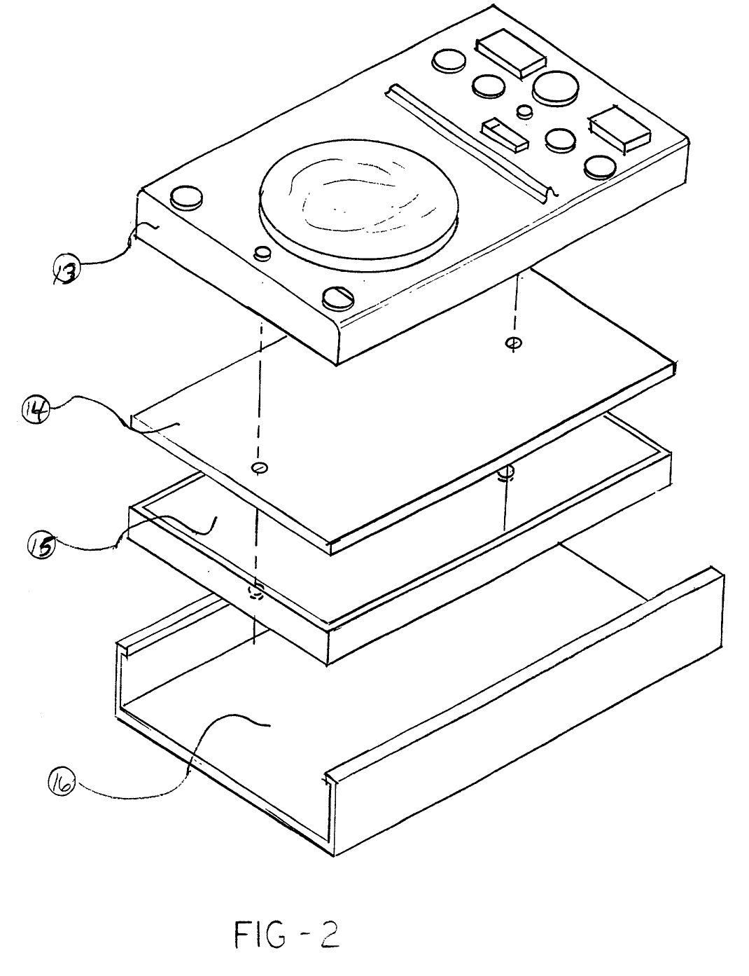

### DESCRIPTION—FIGS. 1 and 2—OPERATION

The device must first be programmed. The operator would press on button 5 and hold down and proceed to push button 7, which allows the meal to be programmed and the number of bites allowed at that meal i.e. breakfast (B) or similar abbreviation and the desired numeric number. The next step is to push button 9 which sets the time lapse desired between bites and processing, i.e. 58 or 110 seconds, etc. The next step is the choice of signals: audible sound, vibrating mode; with or without visual signal-lights; on or off

To operate, push 5 and repeat until the right program appears for that operator in screen 12, breakfast, lunch, dinner, or snack. When eating begins with a bite taken by hand, or food taken with a utensil orally, lay the utensil on, or touch the sensitivity plate 1 to begin count down. A signal will be given after the elapsed time and the ingestion process with food will repeat itself A special signal would warn the operator when the total number of bites or ingested units had been reached and eating should cease for that meal or snack.

Turn the device off 6 and clean and place protective covering on top for storage or transportation by operator.

What is claimed:

1) A behavior changing or modifying device that can altar the eating habits of the operator to induce and maintain proper body weight.
A device that is easily programmable to correct rapid ingestion of nutrients or food so that our hypothalamus can accurately give a signal of satiety so over indulgence can be rectified or eliminated in our daily eating habits.
The device also notifies the operator when he has consumed the correct number of standardized bites of food units in an eating setting to control quantity of ingested food to help maintain body weight.
(1) A food intake monitor comprising of:
A hand held, battery/solar power device that can be programmed for one or several operators of the device for their specific programs.
